(19) United States
(12) Patent Application Publication
(10) Pub. No.: US 2019/0312861 A1
(43) Pub. Date: Oct. 10, 2019

(54) SYSTEM AND METHOD FOR GRID-BASED ONE-TIME PASSWORD

(71) Applicant: CA, Inc., New York, NY (US)

(72) Inventors: Gangadhar KAIRI, Telangana (IN); Satish Kumar SHARAF, Telangana (IN)

(73) Assignee: CA, Inc.

(21) Appl. No.: 15/948,501

(22) Filed: Apr. 9, 2018

(51) Int. Cl. H04L 29/06; H04L 9/32; G06F 21/36; H04W 12/06

(52) U.S. Cl. CPC H04L 63/0838; H04W 12/06; G06F 21/36; H04L 9/3228

(57) ABSTRACT

A method by an authentication server includes storing authentication information comprising at least one sub-grid position associated with a grid pattern and at least one character position associated with a sub-grid pattern. The authentication server generates an authentication grid that includes sub-grids. Each of the sub-grids is disposed at a sub-grid position associated with the grid pattern and includes a plurality of randomly selected characters that are disposed at respective character positions associated with the sub-grid pattern. The authentication server transmits the authentication grid to the user and receives first user input including at least one character. Authentication server determines a one-time password (OTP) based on the authentication grid and the authentication information. The user is authenticated based on a comparison of the OTP to the user input.

### BACKGROUND

The present disclosure relates to security and, in particular, to a method, apparatus, and executable instructions for generating more secure grid-based, one-time passwords.

### SUMMARY

The present disclosure relates to interfaces and, in particular, to a method, apparatus, for generating more secure grid-based, one-time passwords (OTPs).

According to an embodiment of the present disclosure, a method by an authentication server includes storing authentication information associated with a user. The authentication information includes at least one sub-grid position selected from a plurality of sub-grid positions associated with a grid pattern and at least one character position selected from a plurality of character positions associated with a sub-grid pattern. The authentication server generates an authentication grid that includes sub-grids disposed at sub-grid positions associated with the grid pattern. Each of the sub-grids includes randomly selected characters that are disposed at a respective one of a plurality of character positions associated with the sub-grid pattern. The authentication server transmits the authentication grid to at least one device associated with a user and receives first user input comprising at least one character. Based on the authentication grid and the authentication information comprising the at least one sub-grid position and the at least one character position, authentication server 304 determines a one-time password (OTP) for the user. The authentication server performs a comparison of the first user input and the OTP and authenticates the user based on the comparison.

According to another embodiment of the present disclosure, a non-transitory, computer-readable storage medium has instructions stored thereon. The instructions are executable by a computing system to cause the computing system to store authentication information associated with a user. The authentication information includes at least one sub-grid position selected from a plurality of sub-grid positions associated with a grid pattern and at least one character position selected from a plurality of character positions associated with a sub-grid pattern. An authentication grid is generated that includes sub-grids disposed at sub-grid positions associated with the grid pattern. Each of the sub-grids includes randomly selected characters that are disposed at a respective one of a plurality of character positions associated with the sub-grid pattern. The authentication grid is transmitted to at least one device associated with a user and first user input comprising at least one character is received. Based on the authentication grid and the authentication information comprising the at least one sub-grid position and the at least one character position, a one-time password (OTP) for the user. A comparison of the first user input and the OTP is performed, and the user is authenticated based on the comparison.

According to another embodiment of the present disclosure, a server includes a memory storing authentication information associated with users and processing circuitry with access to the memory. The processing circuitry is configured to store authentication information associated with a user. The authentication information includes at least one sub-grid position selected from a plurality of sub-grid positions associated with a grid pattern and at least one character position selected from a plurality of character positions associated with a sub-grid pattern. An authentication grid is generated that includes sub-grids disposed at sub-grid positions associated with the grid pattern. Each of the sub-grids includes randomly selected characters that are disposed at a respective one of a plurality of character positions associated with the sub-grid pattern. The authentication grid is transmitted to at least one device associated with a user and first user input comprising at least one character is received. Based on the authentication grid and the authentication information comprising the at least one sub-grid position and the at least one character position, a one-time password (OTP) for the user. A comparison of the first user input and the OTP is performed, and the user is authenticated based on the comparison.

Certain embodiments of the present disclosure may provide one or more technical advantages. For example, certain embodiments may provide OTPs that can be decrypted only by the intended user. As a result, certain embodiments provide more secure OTP-based authentication, while keeping the OTP strength associated with mobile band communication. Still another advantage may be that OTPs may be protected from shoulder surfing and cameras since, even though user input is captured, the source of the user input within an authentication grid will not be detectable since each character may be displayed multiple places within the authentication grid. Yet another advantage may be that flexibility is increased since users or administrators may choose security level. Still another advantage still may be that since the characters in the authentication grid are randomized on each access and the OTP is invalidated after some time, security is improved. Yet another advantage may be that the encrypted OTP may be send to multiple or alternative computing devices. As such, certain embodiments avoid device dependency.

Other objects, features, and advantages will be apparent to persons of ordinary skill in the art in view of the following detailed description and the accompanying drawings.

### BRIEF DESCRIPTION OF THE DRAWINGS

For a more complete understanding of the present disclosure, needs satisfied thereby, and the objects, features, and advantages thereof, reference now is made to the following description taken in connection with the accompanying drawings. Embodiments of the present disclosure, and their features and advantages, may be understood by referring to FIGS. 1-9, like numerals being used for corresponding parts in the various drawings.

FIGS. 1A and 1B illustrate elements of one-time password (OTP) based authentication, according to a non-limiting embodiment of the present disclosure.

FIGS. 2A and 2B illustrate elements of grid-based OTP authentication for authentication, according to a non-limiting embodiment of the present disclosure.

FIG. 3 illustrates an environment for dynamic grid-based OTP authentication, according to a non-limiting embodiment of the present disclosure.

FIG. 4 illustrates an authentication server for authenticating a user based on an encrypted, grid-based one-time password, according to a non-limiting embodiment of the present disclosure.

FIG. 5 a flow diagram depicting a process by an authentication server for provisioning or registering authentication information for a user, according to a non-limiting embodiment of the present disclosure.

FIGS. 6A and 6B illustrate an example grid pattern having multiple sub-grid positions that are selectable by a user during the provisioning or registering of authentication information for a user, according to a non-limiting embodiment of the present disclosure.

FIGS. 7A, 7B, 7C, and 7D illustrate views of an example sub-grid pattern having multiple character positions that are selectable by a user during the provisioning or registering of authentication information for a user, according to a non-limiting embodiment of the present disclosure.

FIG. 8 is a flow diagram depicting a process 800 by authentication server 304 for authenticating a user based on a dynamically-generated, grid-based OTP, according to a non-limiting embodiment of the present disclosure.

FIGS. 9A and 9B illustrate graphic user interface screens for authenticating a user based on an encrypted, grid-based one-time password, according to a non-limiting embodiment of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language, such as JAVA®, SCALA®, SMALLTALK®, EIFFEL®, JADE®, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to aspects of the disclosure. It will be understood that each block of the flowchart illustrations and/or block diagrams, and combinations of blocks in the flowchart illustrations and/or block diagrams, can be implemented by computer program instructions. These computer program instructions may be provided to a processor and/or processing circuitry of a general-purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The terminology used herein is for the purpose of describing particular aspects only and is not intended to be limiting of the disclosure. As used herein, the singular forms “a,” “an,” and “the” are intended to comprise the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

Typically, end-user security of automatic teller machine (ATM) and debit cards primarily depends on the user holding and keeping the card safe, and keeping the user's personal identification number (PIN) secret. Debit cards are usable in environments other than at an ATM, such as for online purchasing.

As referred to herein, an “account PIN,” which may also be referred to as a “static PIN,” refers to the PIN provided to the account holder by the account provider for use by the account holder to authorize transactions on the user's account through a transaction interface such as an ATM terminal or POS interface. Typically, the user account PIN is a static, or fixed datum, for example, a string of four alpha-numeric characters, which may remain unchanged for the life of the account, or which may be infrequently changed only when necessary. For example, the account PIN may be changed when an account card, such as an ATM or debit card associated with the user account is lost, stolen or reissued. The account PIN may be defined or assigned by the account provider, or the account provider may allow the account holder to select the account PIN, for example, by selecting four alphanumeric characters of the account holder's preference.

Users are subject to attacks from many venues. For example, “phishing” attacks are attacks on the account PIN itself The static nature of the magstripe data on the ATM card and the use of a static account PIN aggravates the problem. During the life of the ATM or debit card, which may be typically up to three years, the magstripe data and PIN do not change, e.g., the magstripe data is static, and the PIN is static. The same static PIN is used to authorize each and every transaction conducted with the ATM card on the user's account. If an attacker obtains the card and PIN, he can easily compromise the account, which may go undetected until the user reviews an account statement, or an event such as an overdraft notifies the user that the account has been compromised.

The security of PIN authorized transactions, such as ATM transactions, is vulnerable to a number of attack methods, which may include the debit or ATM magstripe being read by a skimmer or similar device attached to an ATM terminal, point-of-sale (POS) terminal or other form of magnetic card reader. The card can be “cloned” using the magstripe information obtained from the skimmer. The user's static PIN can be obtained by visual observation of the PIN being entered into an ATM or POS terminal, which may be called “shoulder-surfing.” The obtainment of the user's static PIN may also be facilitated by the use of surveillance camera or other recording device. The user's static PIN can be obtained by other means, for example, during an online transaction where the PIN, which is not protected cryptographically prior to input into the online interface, and other account data may be recorded and obtained using a “Trojan” type virus or other malicious virus to record and retrieve the account information and PIN for use in subsequent attacks on the user's account.

In certain circumstances, such as when a mobile application is used to conduct financial transactions and other types of high risk transactions, additional security may be required. Accordingly, systems and methods have been devised to replace the static PIN for a user account with a dynamic PIN structure, wherein a unique, single use PIN, also referred to as a one-time PIN (OTP) or one-time passcode (OTP), is provided by a user accountholder's mobile device. The OTP is a password that is valid for only one login session or transaction, on a computer system or other digital device.

In a non-limiting example, the generated OTP is provided as a verifiable or authentic PIN which may be substituted for the account PIN in a PIN-required financial transaction, e.g., an ATM transaction or point of sale (POS) debit transaction using a user or account holder card which may be an ATM or debit card. The POS transaction may be a debit transaction in a “brick and mortar” or a payment or purchase made through an online POS system. The system and method described herein to generate an OTP from a user device can be adapted to any system where a PIN input is required for access, approval, authorization or authentication, e.g., for secure access to an online system, computer network, database, etc., or online authentication of personal identity or approval of a transaction, or for any other representation of an account number or user identification which is used in conjunction with a PIN for a transaction, authorization or authentication. For example, the card may be a medical insurance card with a magnetic stripe and the PIN may be required for the release of medical information, authorization of a prescription or authentication of the patient subscriber to the insurance provider. As another example, the card may be a credit card which requires PIN authorization for some or all transactions. As still another example, the card may be a secure access card used with a card reader and PIN pad for authorization to a secured area, which may be a physical area, such as a building, or to secure network or database.

By definition the OTP can only be used one-time, for a single PIN-required transaction. For the next card use, e.g., for the next PIN-required transaction, another different OTP must be generated by the OTP generator on the user device and provided to the user cardholder. This effectively prevents many attacks on PIN-required transactions. For example, when an attacker has attached a “skimmer” to an ATM, the skimmer can capture the magstripe data as the card is swiped to initiate a transaction and can record the OTP entered to authorize the transaction. The user may complete the transaction unaware that the user's card magstripe data and the inputted OTP have been obtained by the attacker. However, since the OTP has been used for the transaction just completed, the same OTP cannot be used again, so a subsequent attack using the skimmed magstripe and the already used OTP is foiled. Even if the attacker were to prevent the user's first (legitimate) transaction and use the OTP himself, the attacker is limited to at most one fraudulent transaction using the OTP, thereby substantially limiting the threat to the user's account.

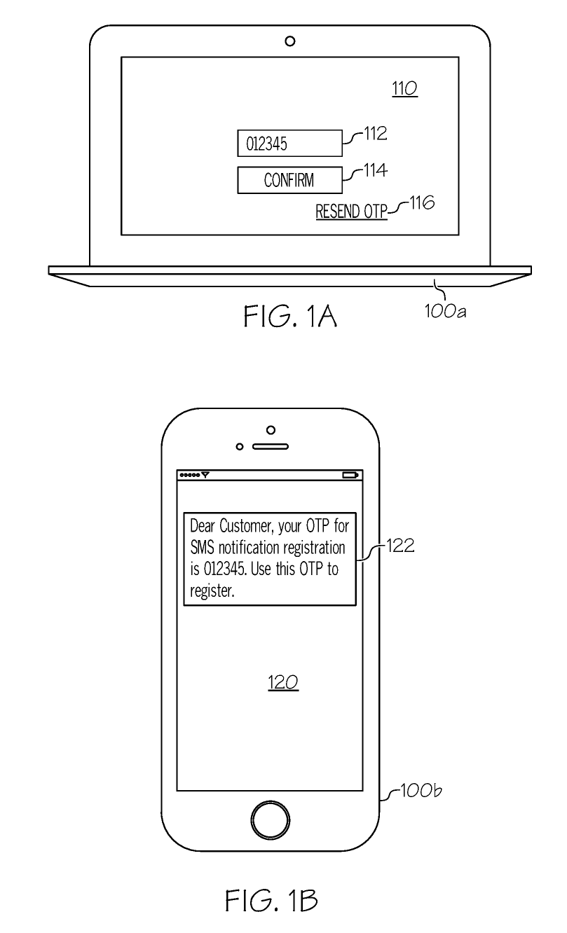

FIGS. 1A-1B illustrate elements of one-time password (OTP) based authentication. Specifically, in a depicted example scenario, the user conducts an on online transaction using a first graphic user interface (GUI) screen 110 on first computing device 100a and receives the OTP via a second GUI 120 on a second computing device 100b. First computing device 100a is depicted as a laptop computer in FIG. 1A and second computing device 100b is depicted as a mobile device in FIG. 1B; however, it is generally recognized that the transaction can be conducted and/or the OTP can be received on any type of computing device. Likewise, in particular embodiments, the transaction can be conducted and the OTP may be received on the same computing device 100a. As still other modifications, it is recognized that the user account may be an ATM or debit account associated with a user ATM/debit card and the account transaction may be conducted on an ATM transaction, or a debit card transaction which may be a point-of-sale (POS) transaction, or any other transaction requiring the user to provide a user PIN to authorize the transaction.

For example, in a typical POS transaction, a GUI 110 such as shown in FIG. 1A may be displayed to the user near the conclusion of the transaction. Initially, user input box 112 of GUI 110 is empty and/or may include an indicator that identifies that a OTP should be entered into user input box 112 by the user. Soon after or simultaneously with the display of GUI 110 on first computing device 100a, a second GUI 120, as shown in FIG. 1B, is displayed to the user on second computing device 100b. Second GUI 120 includes a message 122 that includes the OTP to be used for finalizing the transaction being conducted on first computing device 100a. For example, in the depicted embodiment, the message 122 comprising the OTP is received as a SMS message. However, message 122 may be alternatively be received as an email message or any other suitable message that may be received on either of computing devices 100a and 100b or another computing device associated with the user.

After receiving message 122 including the OTP, the user enters the OTP into user input box 112 of GUI 110. In the depicted example, the user has entered the OTP of ‘012345’ into user input box 112. After entry of the OTP, the user selects the confirm button 114 to cause the transaction to be submitted to the financial institution for authentication and finalization. For example, in the case of an ATM transaction, the entered OTP may be transmitted over the ATM network to the user's bank or provider system. The provider system, e.g., the bank issuing the user's ATM card used for the transaction, is configured to verify the OTP generated by the user device as an authentic PIN associated with the user's ATM card, to authorize an ATM transaction. The provider system may be configured to generate an authenticating OTP, for comparison with the generated OTP inputted into the ATM, to verify the generated OTP as an authentic PIN for the user's ATM card, and thereby determine an authorization result for the ATM transaction.

As depicted, GUI 110 as includes a resend OTP button 116. If, the OTP does not work (such as where too much time passes between the receipt of the OTP on GUI 120 and the entry of the OTP on GUI 110 or the user mistypes the OTP), the user can press the resend OTP button 116 to cause a new OTP to be generated and transmitted to the user on computing device 100a and/or 100b.

According to certain other embodiments, the OTP may not be transmitted to the computing device associated with the user. Instead, computing devices 100a and/or 100b may be provided with an OTP application that includes at least one user account-specific OTP key configured to dynamically generate an OTP that is useable as a PIN for a user account.

As stated above, the OTP application may be configured with one or more OTP generators. Each of the OTP generators may be defined by a specific user account. For example, a first OTP generator may be configured for the user's ATM card for a first bank account, and a second OTP generator may be configured for the user's debit card for a second bank account. The system and method described herein may also be provided and securely hosted in JavaScript™ within a browser used by a desktop computer, laptop, netbook, or other Internet accessible computing device, to provide OTPs, for example, for online transactions. The OTP generating software client can be further configured to be secured for use exclusively with that unique user device, by incorporating a machine identification parameter derived as a machine effective speed calibration (MESC) in the OTP application and authentication process.

The OTP generator may use an industry-standard algorithm for OTP generation, including a HMAC-Based One-Time Password algorithm, also referred to as HOTP (from the Open Authentication initiative), and a Europay, MasterCard and Visa Chip Authentication Program algorithm, also referred to as EMV/CAP, a payment industry OTP standard first developed by MasterCard, or may use a customized algorithm. The OTP generator is defined by a key or secret associated with the user's account, e.g., with the user's ATM or debit card, where the key or secret may be encrypted or obfuscated using a method of cryptographic camouflaging as described herein to provide an OTP generation key, also referred to as an OTP key. The key or secret may be camouflaged using a PIN such as the user account PIN, a machine identifier such as a machine effective speed calibration (MESC) as described herein, which is defined by and unique to the user's device, another data element, or a combination of two or more of a PIN, a MESC and a data element.

To use the OTP generator associated with an OTP application, the user selects the OTP generator associated with the user ATM card with which the user is planning to conduct a transaction, from the OTP application on computing device 100b. The user may obtain an OTP from the user device by opening or selecting the OTP application on the computing device 100b, and if required, selecting a “generate OTP” button or similar command, with no requirement for the user to input a PIN, e.g., the OTP is generated and provided without any further user input. Alternatively, the user may be required to enter the user's account PIN for the ATM card to be used for the transaction, or another data element, for example, an MESC or a transaction amount, which may be used to authenticate the user to the OTP application, to generate the OTP, or to authenticate the user or user transaction to an authenticating server. In other embodiments, the OTP application may be linked to the financial account of the user such that when a transaction is initiated using the user's ATM or debit card, the OTP application may receive a message from the financial institution and automatically generate an OTP in response to the message. In such an embodiment, message 122 may be a pop-up message generated by the OTP application.

The OTP generator uses the camouflaged key to generate an OTP, which is provided to the user on GUI 120, for use as a PIN input for a single user transaction, for example, for entry into the ATM to authorize the planned ATM transaction or to finalize an online transaction. If the user chooses to conduct a subsequent transaction with the same ATM or debit card where a subsequent PIN input is required, the user repeats the process, selecting the OTP generator on the user's device to generate another OTP which is inputted to a banking system to authorize the subsequent transaction.

Where the OTP replaces an account PIN to authorize a user transaction, the OTP may be configured or provided in the same form as the account PIN for which the OTP is substituted. For example, if the user account PIN is a string of four alpha-numeric characters, the OTP may also be configured as a string of four alpha-numeric characters. In the depicted embodiment, message 122 identifies the OTP for the transaction as being ‘012345,’ which is a string of six numeric characters. In this way the dynamically generated OTP can be used in any context where the static PIN could have been used; for direct input into an ATM; input into a website for an online purchase; written on a mail order form or provided verbally in a telephone transaction, by way of non-limiting example.

An advantage that is addressed by OTPs is that, in contrast to static passwords, they are not vulnerable to replay attacks. This means that a potential intruder who manages to record an OTP that was already used to log into a service or to conduct a transaction will not be able to abuse it, since the OTP will no longer be valid. A second major advantage is that a user who uses the same (or similar) password for multiple systems, is not made vulnerable on all of them, if the password for one of these is gained by an attacker. OTPs have been discussed as a possible replacement for, as well as enhancer to, traditional passwords.

However, OTP-based authentication is not without its flaws. OTPs are difficult for human beings to memorize. Additionally, there is no additional security to ensure that only an authorized person is able to use the OTP. Since an OTP comes to a device, anyone who has the device may be able to use the OTP. Accordingly, a device that is lost or stolen may be subject to increased risk of fraud. Conversely, rightful owner of the device has lost the mechanism for receiving the OTP and, thus, may not be able to be authenticated.

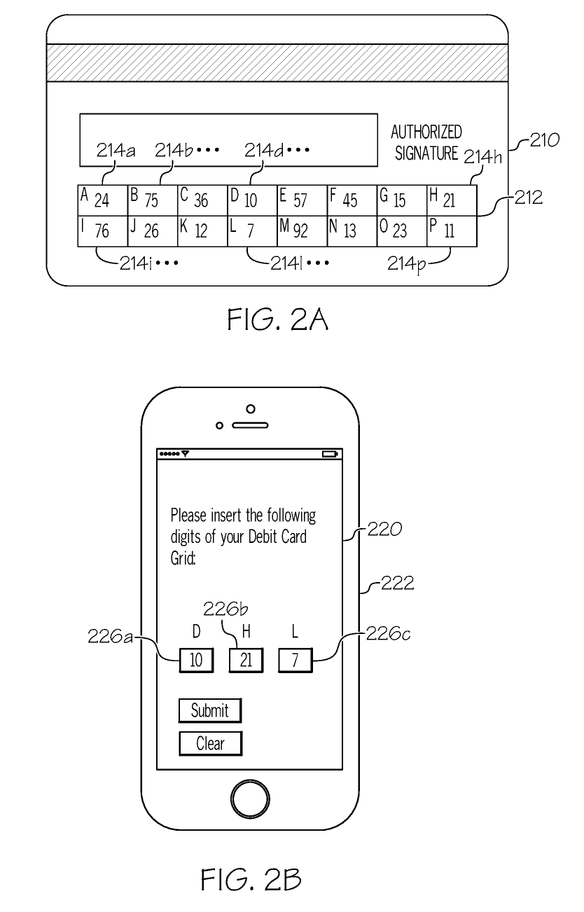

Grid-based OTP authentication is a specific type of OTP authentication for securing user logins by requiring the user to enter values from specific cells in a grid whose content should be only accessible to the user and the service provider. FIGS. 2A-2B illustrate elements of grid-based OTP authentication, according to a non-limiting embodiment of the present disclosure. Specifically, FIG. 2A illustrates a debit card 210 that includes an authentication grid 212 printed directly on it, and FIG. 2B illustrates a GUI 220 for receiving a OTP on a computing device 222. However, while a debit card 210 is illustrated, authentication grid 212 may be printed on any other card, paper, or suitable medium.

According to certain embodiments, authentication grid 212 includes a number of cells 214a-p. Each cell 214a-p is associated with a randomly selected letter and a randomly selected number. In the particular illustrated example, there are sixteen cells 214a-p in authentication grid 212. The sixteen grid cells 214a-p are each associated with a selected one of the first sixteen letters of the alphabet (i.e., A, B, C, . . . P). Though the assignment is shown to be sequential from A to P, the assignment of letters to each cell 214a-p may be randomized in other embodiments.

In addition to the associated letter, each cell 214a-p is assigned or otherwise associated with a randomly selected number. For example, cell 214d, which is associated with the letter D, is also associated with the number 10. As additional examples, cell 214h, which is associated with the letter H, is also associated with the number 21, and cell 214l, which is associated with the letter L, is also associated with the number 7. In the illustrated example, the randomly assigned numbers range between 0 and 99. However, the numbers may fall within any suitable range. Additionally, though authentication grid 212 is not depicted as including any repeated numbers, it is recognized that authentication grid 212 may include repeated numbers in other embodiments. Because the grid consists of letters and numbers in rows and columns, the method is sometimes referred to as bingo card authentication.

In one example scenario, authentication grid 212 of FIG. 2A may be used when a user logs into the user's bank account using a mobile or web-based application or when a user conducts an online transaction using computing device 222 of FIG. 2B. For example, in a particular scenario, when the user of computing device 222 attempts to log into the user's bank account with his user name and password, GUI 220 may be displayed to the user to prompt the user to input the characters from a number of randomly-selected cells in the authentication grid. As depicted, GUI 220 includes three user input boxes 226a-c for entry of a three-digit OTP. Initially, user input boxes 226a-c may be empty. However, each user input box 226a-c may include an indicator that identifies a letter selected from the letters associated with cells 214a-p. For example, first user input box 226a includes an indicator identifying the letter “D.” Likewise, second user input box 226b and third user input box 226c include indicators identifying the letters “H” and “L,” respectively. To enter the OTP, the user must use authentication grid 212 on debit card 210 to determine the numerals that are associated with each of the letter. Thus, for the first user input box 226a identified by the “D” indicator, the user would use authentication grid 212 to determine that the numeral associated with the letter “D” is 10. Likewise, the user would use authentication grid 212 to determine that the numeral associated with the letter “H” is 21 and the numeral associated with the letter “L” is 7. Thereafter, the user enters the numbers 10, 21, and 7 into the first, second, and third user input boxes 212a-c, respectively. If the user enters the correct character sequence, access is granted to the account. Or, in the case of an online purchase, the user may be authenticated for purposes of making the financial transaction.

Similar to the OTP authentication described above with regard to FIGS. 1A and 1B, grid-based authentication is a type of two-factor authentication because it requires that the user provide proof of something that they know (i.e., the user name and password associated with the account) as well as proof of something that they have (i.e., the possession of the debit card having the grid printed thereon). While grid authentication protects against replay attacks because the same characters selected for one login cannot be reused, the grid may be hard for some users to memorize. Accordingly, the authorized user may be required to carry the grid with them at all times so that transactions can be completed as necessary. This may be the case even during online purchases where the card has no rule to play in the transaction. As another drawback, there is no mechanism in place to prevent an unauthorized person with exceptional memory skills from memorizing or copying the entire grid. Thus, grid authentication is also vulnerable to an attack method like brute force cracking, in particular if the same grid is used for an extended period of time or if the debit card is lost or stolen. Accordingly, there is a need in the marketplace for more secure OTP-based authentication. Embodiments of the present disclosure may address the above problems, and other problems, individually and collectively.

According to certain embodiments, for example, systems and method may be provided for the dynamic generation of an authentication grid for use in grid-based authentication. In contrast to the grid-authentication mechanism described above, which includes a static grid being printed on a debit card, the authentication grid is dynamically generated and transmitted to a user's computing device for use in a particular transaction. Each dynamically-generated authentication grid includes a plurality of sub-grids disposed at pre-defined sub-grid positions that are determined based on authentication information shared between the user and the financial service provider during a registration or provisioning session. Because the dynamically generated grid is only valid for a limited time, a new dynamically generated grid must be generated for each transaction.

Certain embodiments of the present disclosure may provide one or more technical advantages. For example, the authentication grid is encrypted and transmitted to the user's computing device such that it can be decrypted and decoded only by the intended user. Additionally, because the grid is generated dynamically for each individual transaction, certain embodiments protect against shoulder surfing and the unlawful use of cameras for obtaining a copy of the authentication grid for subsequent use. As another example technical advantage, since the numbers and their positions are randomized on each access, more robust grid-based authentication is provided.

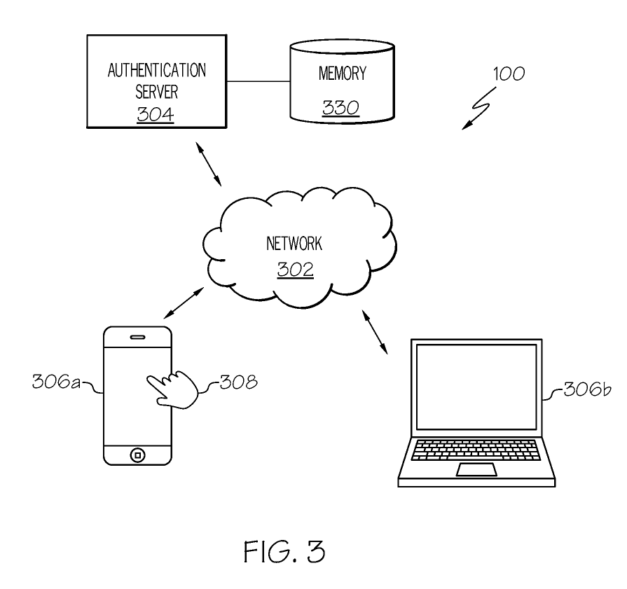

FIG. 3 illustrates an exemplary authentication system 300 in which the subject matter of the disclosure can function. The system 300 generally includes a public network 302 communicatively coupling an authentication server 304 to one or more client devices 306a-b.

The network 302 generally refers to any interconnecting system capable of transmitting audio, video, signals, data, messages, or any combination of the preceding. Further, the network 302 may include all, or a portion of a public switched telephone network (PSTN), a public or private network, a local area network (LAN), a metropolitan area network (MAN), a wide area network (WAN), a local, regional, or global communication or computer network such as the Internet, a wired or wireless network, other suitable communication link, or any combination of similar systems.

Computing devices 306a-b may communicate with server 304 via network 302, which may include any number of subnetworks. Network 302 may transmit information in packet flows in one embodiment. A packet flow includes one or more packets sent from a source to a destination. A packet may comprise a bundle of data organized in a specific way for transmission, and a frame may comprise the payload of one or more packets organized in a specific way for transmission. A packet-based communication protocol, such as Internet Protocol (IP), may be used to communicate the packet flows.

A packet flow may be identified in any suitable manner. As an example, a packet flow may be identified by a packet identifier giving the source and destination of the packet flow. A source may be given by an address, such as the IP address, port, or both. Similarly, a destination may be given by an address, such as the IP address, port, or both.

According to certain embodiments, network 302 may utilize protocols and technologies to transmit information. Example protocols and technologies include those described by the Institute of Electrical and Electronics Engineers, Inc. (IEEE) 802.xx standards, such as 802.11, 802.16, or WiMAX standards, the International Telecommunications Union (ITU-T) standards, the European Telecommunications Institute (ETSI) standards, Internet Engineering Task Force (IETF) standards, the third-generation partnership project (3GPP) standards, or other standards.

According to certain embodiments, authentication server 304 may include a file server, a domain name server, a proxy server, a web server, a computer workstation, or any other device suitable for authenticating a transaction. Further, the authentication server 304 may use any appropriate operating system, such as MS-DOS®, MAC-OS®, WINDOWS®, UNIX®, or any other operating system currently in existence or developed in the future.

According to certain embodiments, authentication server 304 maintains user and/or account information in memory 330. The account information may be used in the authentication of users and the completion of transactions by such users. According to certain embodiments, memory 330 may include storage media, such as hard disk drives, volatile or non-volatile memory, optical disk storage devices, or any other storage devices, including removable storage devices.

As used here, the terms “computing device,” “wireless device,” and “mobile device” generally refer to any suitable device operable to communicate with the authentication server 304 through the network 302. Computing devices 306a-b may include, for example, a personal digital assistant, a computer (e.g., a laptop, a desktop workstation, a server, etc.), a cellular phone, a mobile internet device (MID), an ultra-mobile PC (UMPC), or any other device operable to communicate with the authentication server 304 through the network 302. Further, computing devices 306a-b may employ any known operating systems such as MS-DOS®, PC-DOS®, OS-2®, MAC-OS®, or any other appropriate operating systems.

In particular embodiments of the invention, communications computing devices 306a-b and authentication server 304 may be effected according to one or more secure wireless communication protocols or WLAN protocols, such as portions or all of the Wired Equivalent Privacy (WEP) protocol, the Robust Security Network (RSN) associated with the IEEE 802.11 protocol, the IEEE 802.1x protocol, the Advanced Encryption Standard (AED), the Temporal Key Integrity Protocol (TKIP), Extensible Authentication Protocol over LAN (EAPOL) algorithms or protocols (such as EAP-TTLS, PEAP, or CISCO's LEAP or EAP-FAST protocols, for example), WiFi Protected Access (WPA) protocol, WiFi Protected Access Pre-shared key (WPA-PSK) protocol, WiFi Protected Access Version 2 (WPA2) protocol, or WiFi Protected Access Version 2 Pre-shred key (WPA2-PSK) protocol, for example.

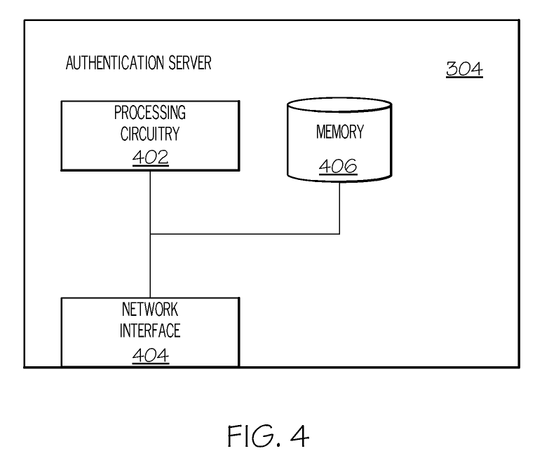

FIG. 4 illustrates an authentication server 304 for the dynamic generation of an authentication grid for use in grid-based authentication, according to a non-limiting embodiment. As depicted, authentication server 304 includes a processing circuitry 402, a network interface 404, and a system memory 406. The network interface 404 connects authentication server 304 to network 302. The processing circuitry 402 may be utilized for the processing requirements of authentication server 304. In certain embodiments, processing circuitry 402 may be operable to load instructions from a hard disk into memory 406 and execute those instructions.

Network interface 404 may refer to any suitable device capable of receiving an input, sending an output from authentication server 304, performing suitable processing of the input or output or both, communicating with other devices, and so on. For example, the network interface 404 may include appropriate modem hardware, network interface card, and similar devices. Further, the software capabilities of the network interface 404 may include protocol conversion and data processing capabilities, to communicate through a LAN, WAN, or other communication system, allowing authentication server 304 to communicate to other devices. Moreover, the network interface 404 may include one or more ports, conversion software, or both.

Processing circuitry 402 can be any suitable device capable of executing instructions to perform operations for authentication server 304. Processing circuitry 402 may include microprocessors, microcomputers, microcontrollers, digital signal processors, central processing units, processing circuitry, state machines, logic circuitries, and/or any devices that manipulate signals based on operational instructions. For example, processing circuitry 402 may be any central processing unit (CPU), such as the Pentium processor, the Intel Centrino processor, and so on.

According to certain embodiments, for example, processing circuitry 402 may operate to enroll or register a user for the provisioning of authentication information associated with the user. Later, when the user conducts a transaction, processing circuitry 402 may use the authentication information to dynamically generate an authentication grid for use in grid-based authentication. For example, processing circuitry 402 may operate to generate a plurality of sub-grids and, based on the authentication information, place the sub-grids at sub-grid positions within the authentication grid. According to certain embodiments, processing circuitry 402 may transmit the dynamically generated grid including the plurality of sub-grids to a computing device associated with the user. Thereafter, processing circuitry 402 may receive user input from the user, which processing circuitry 402 may use to authenticate the user.

Further, the system memory 406 may be any suitable device capable of storing computer-readable data and instructions. For example, the system memory 406 may include logic in the form of software applications, random access memory (RAM) or read only memory (ROM). Further examples may include mass storage medium (e.g., a magnetic drive, a disk drive, or optical disk), removable storage medium (e.g., a Compact Disk (CD), a Digital Video Disk (DVD), or flash memory), a database and/or network storage (e.g., a server), other computer-readable medium, or a combination of any of the preceding.

According to certain embodiments, memory 406 stores authentication information, which may include data generated or received during a registration or provisioning process by a user. As will be described in more detail below, the authentication information may include user-selected sub grid positions within an authentication grid. The authentication information may also include user-selected character positions within a sub-grid.

For the purpose of associating the authentication information with a user, memory 406 may also store account information, which may include any data generated or received for the completion of transactions by computing devices 306a-b. Where the authorization server 304 is associated with a financial institution, account information may include credit or debit card information including account number, expiration dates, security codes, authentication information, user-selected settings, and other suitable information. Additionally, memory 406 may be also used to store transaction related information associated with an account, in a particular embodiment. Such information may also include merchant identification information, location information, date information, amount information, requesting user information, or other suitable transaction-specific information, according to certain embodiments.

Although authentication server 304 is depicted as including only a single network interface 404, processing circuitry 402, and memory 406, these items may be present in multiple items, or combined items, as known in the art. It is also recognized that other embodiments may include the placement of one or more of these components elsewhere in authentication server 304.

According to certain embodiments, authentication server 304 or another service provider may provide a mobile application that is downloadable to computing devices 306a-b. In a particular embodiment, for example, the mobile application may be a financial services or banking application that is provided by a financial institution. After the mobile application is downloaded to one or multiple computing devices 306a-b, the user may use the mobile application to provision and register authentication information. In other embodiments, the provisioning and registering of authentication information may be performed using a web-based application provided over the Internet.

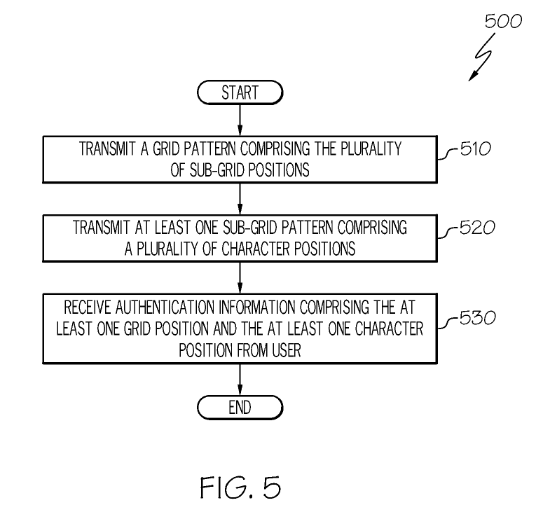

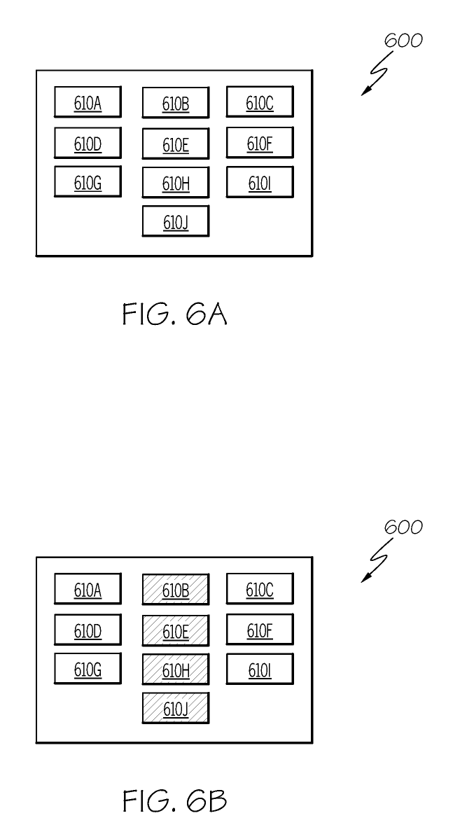

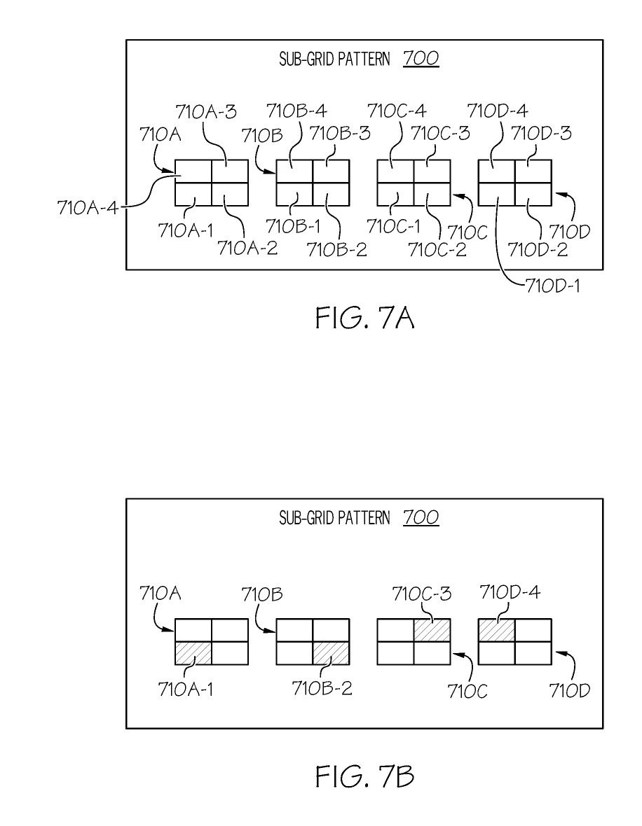

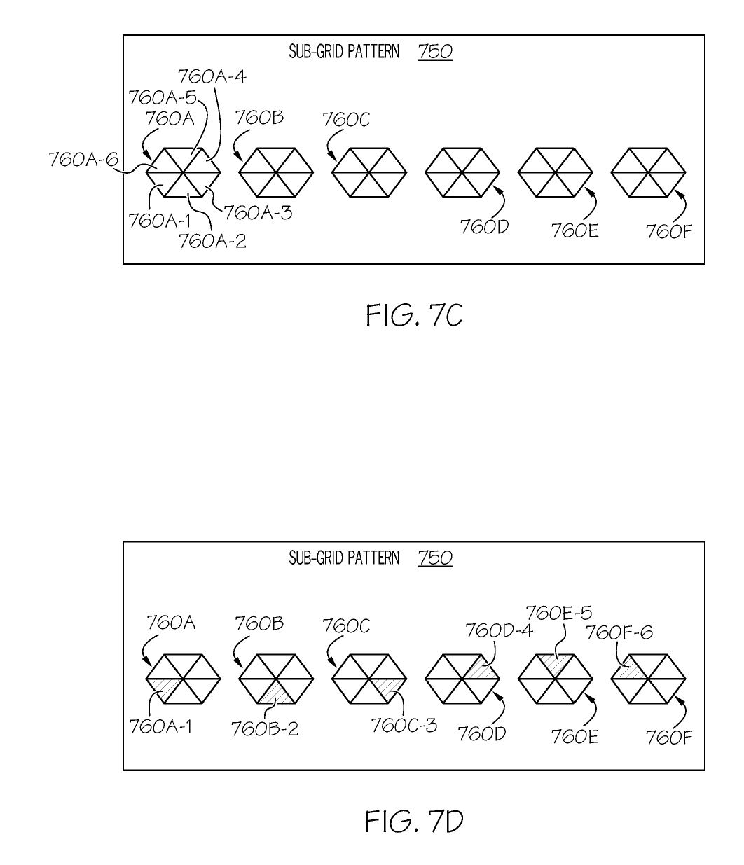

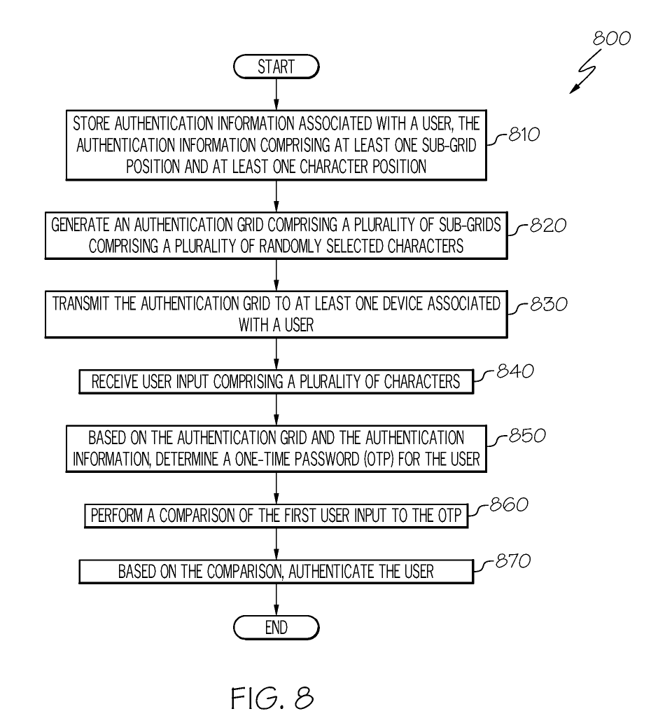

FIG. 5 is a flow diagram depicting a process 500 by authentication server 304 for provisioning or registering authentication information for a user 308, according to a non-limiting embodiment of the present disclosure. The process 500 may be considered side-by-side with FIGS. 6A-6B and 7A-7D, which illustrate elements that may be displayed to user 308 during the provisioning process.

As depicted in FIG. 5, the method begins at step 510 when authentication server 304 generates and transmits one or more grid patterns to a computing device 306a-b for display to user 308. FIG. 6A illustrates an example grid pattern 600 that includes multiple sub-grid positions 610A-J that may be displayed to and selected by user 308 during the provisioning or registering process 500. In the depicted example, the grid pattern 600 is configured like a telephone keypad. Thus, the grid pattern 600 is laid out in a rectangular array of ten sub-grid positions 610A-J arranged as four rows and three columns, omitting the lower left and lower right positions that commonly are assigned to special character symbols on a telephone keypad. However, the depicted grid pattern 600 is provided only as an example. The grid pattern may include any number of sub-grid positions in any shape or configuration.

According to certain embodiments, user 308 may select a subset of the plurality of sub-grid positions 610A-J. In a particular embodiment, the subset must be at least one sub-grid position selected from sub-grid positions 610A-J. In another embodiment, the subset may be equal to or less than the total number of sub-grid positions 610A-J displayed in grid pattern 600.

According to certain embodiments, the number of sub-grid positions 610A-j to be selected by the user may vary depending on the user settings and/or a desired security level. For example, in a particular embodiment, user 308 may select the number of grid-positions 610A-J to be stored as authentication information. This selection may occur before or concurrently with the selection of the actual sub-grid positions 610A-J. In another embodiment, the service provider associated with authentication server 304 may determine the number of sub-grid positions 610A-J to be selected by user 308. According to certain embodiments, the number of grid positions 610A-J selected by the user may correspond to the number of characters in a one-time password to be generated in a subsequent authentication process.

FIG. 6B illustrates example grid pattern 600 after user 308 has selected a subset of sub-grid positions 610A-J within grid pattern 600. In the depicted example embodiment, user 308 has selected the following four sub-grid positions: 610B, 610E, 610H, and 610J. In a particular embodiment where grid pattern 600 is displayed to user 308 on a computing device 306a-b having a touch screen, user 308 may select a sub-grid position 610A-J by touching it.

After selection of the sub-grid positions 610A-J, computing device 306a-b may record the particular sub-grid positions 610A-J selected by the user and, in some embodiments, the order in which the user selected the sub-grid positions 610A-J. Likewise, and as will be described in more detail below, user 308 will be required to remember the selected sub-grid positions 610A-J for future use during grid-based authentication. This may form a portion of the “something that the user knows” portion of two-factor authentication during future authentication sessions. However, in contrast to previous grid-based authentication systems, user 308 only needs to remember the sub-grid positions 610A-J rather than specific characters associated with the sub-grid positions 610A-J.

Returning to FIG. 5, the method continues when authentication server 304 generates and transmits one or more sub-grid patterns to computing device 306a-b for display to user 308. FIG. 7A illustrates an example sub-grid pattern 700. According to certain embodiments, the sub-grid pattern 700 includes at least one sub-grid 710A-D that may be displayed to user 308 during the provisioning or registering process 500. In a particular embodiment, the sub-grid pattern 700 may include a n-number of sub-grids 710A-D and n may correspond to the number of characters to be included in OTPs that to be subsequently generated based on the sub-grid pattern 700. In the depicted example embodiment, n is set to four. Thus, sub-grid pattern 700 include four sub-grids 710A-710D.

According to certain embodiments, each sub-grid 710A-D includes a m-number of character positions. In the particular embodiment depicted in FIG. 7A, m is also set to four. Thus, each sub-grid 710A-D includes four character positions. For example, sub-grid 710A has the following four character positions 710A-1, 710A-2, 710A-3, and 710A-4. As another example, sub-grid 710B has the following four character positions 710B-1, 710B-2, 710B-3, and 710B-4. Likewise, sub-grid 710C has the following four character positions 710C-1, 710C-2, 710C-3, and 710C-4, and sub-grid 710D has the following four character positions 710D-1, 710D-2, 710D-3, and 710D-4. Similar to n, the value of m may be selected to correspond the number of characters to be included in OTPs that are subsequently generated based on the sub-grid pattern 700. However, and as described in more detail below, it is recognized that each sub-grid 710A-D may include any suitable number of character positions 710A-1 through 710A-m. It is further recognized that m may or may not correspond to the number of sub-grids 710A-D displayed to user 308 and/or the number of characters to be included in subsequently generated OTPs.

User 308 may then select at least one character position for each sub-grid 710A-D. In a particular embodiment where computing device 306a-b includes a touch screen, user 308 may select a character position for each sub-grid 710A-D by touching a character position in each respective sub-grid 710A-D.

FIG. 7B illustrates example sub-grid pattern 700 after user 308 has selected a character position for each sub-grid 710A-D. In the depicted example embodiment, the character positions that are shaded indicate user selections. Thus, user 308 has made the following selections from sub-grid pattern 700: character position 710A-1 for sub-grid 710A, character position 710B-2 for sub-grid 710B, character position 710C-3 for sub-grid 710C, and character position 710D-4 for sub-grid 710D. After selection of the character positions, computing device 306a-b may record the particular character positions selected by the user and, in some embodiments, the order in which the user selected the character positions. Thus, in the particular example illustrated in FIG. 7B, the selected character positions may be recorded in the following order: 710A-1, 710B-2, 710C-3, and 710D-4. In a particular embodiment, each selection may comprise a unique selection of a character position. For example, if user 308 selects the lower, left character position for sub-grid 710A, the user may not be able to select the lower, left character position for any other sub-grid position. More specifically, if the user selects character position 710A-1 for sub-grid 710A, the user cannot select 710B-1, 710C-1, or 710D-1. In other embodiments, the user may be able to select any character position in a sub-grid 710A-D whether or not that character position has been selected for another sub-grid 710A-D.

According to certain embodiments, the value of n (i.e., the number of characters in a desired OTP and, thus, the number of sub-grid positions) and the value of m (the number of character positions) may be selected to generate an authentication grid of n×m complexity. The complexity may be varied based on a desired level of security. For example, where a simple 4-digit OTP is desired, an authentication grid of 4×4 may be generated based on the user input. However, to add additional complexity to the authentication grid, either or both of n and m may be increased. Thus, process 500 is not limited to provisioning authentication information for the generation of an 4×4 authentication grid. The process may be used to provision authentication information for the generation of authentication grids of 4×6, 6×6, or 4×9, which may provide 10 C4×4, 10 c4×6, or 10 C4×9 combination of brute force to know the correct OTP. Other authentication grids may also be possible of any desired complexity.

FIGS. 7C-7D illustrate an alternative example sub-grid pattern 750 for the provisioning of authentication information to subsequently generate authentication grids of a 6×6 complexity. Specifically, as shown in FIG. 7C, sub-grid pattern 750 includes six sub-grids 760A-F. Further, each sub-grid 760A-F has having six character positions. Thus, in this example embodiment, both n and m are set to six.

Similar to sub-grid pattern 700 described above, sub-grid pattern 750 may be transmitted and displayed to user 308 during the provisioning or registering process 500. User 308 may then be required to select a character position for each sub-grid 760A-F. FIG. 7D illustrates example sub-grid pattern 760 after user 308 has selected character positions. Again, the character positions that are shaded indicate user selections. Thus, in the specific example embodiment shown, user 308 has made the following selections: character position 760A-1 for sub-grid 760A, character position 760B-2 for sub-grid 760B, character position 760C-3 for sub-grid 760C, character position 760D-4 for sub-grid 760D, character position 760E-5 for sub-grid 760E, and character position 760E-6 for sub-grid 760F. After selection of the character positions, computing device 306a-b may transmit, to authentication server 304, the particular character positions selected by the user and, in some embodiments, the order in which the user selected the character positions.

Returning to FIG. 5, the method then proceeds to step 530 when authentication server 304 receives authentication information from computing device 306a-b of the user 308. According to certain embodiments, the authentication information includes the at least one sub-grid position selected by user 308. Using the embodiment of FIG. 6B as an example, the authentication information would include an indication that user 308 selected a subset of sub-grid positions corresponding to sub-grid position 610B, sub-grid position 610E, sub-grid position 610H, and sub-grid position 610J within grid pattern 600. Additionally, according to certain embodiments, the authentication information includes at least one character position selected by user 308. Using the example embodiment of FIG. 7B as an example, the authentication information would include an indication that user 308 selected the following character positions: character position 710A-1 for sub-grid 710A, character position 710B-2 for sub-grid 710B, character position 710C-3 for sub-grid 710C, and character position 710D-4 for sub-grid 710D.

Thereafter, authentication server 304 may use the authentication information to generate an authentication grid for authenticating the user for a transaction. During future authentication sessions, the sub-grid positions and character positions selected by the user form the portion of the “something that the user knows” of two-factor authentication. In contrast to previous grid-based authentication systems, however, user 308 only needs to remember the sub-grid positions 610A-610J and character positions rather than any specific characters associated with those positions.

Because process 500 enables user 308 to be involved with the selection of the sub-grid positions and character positions, user 308 may more easily determine a one-time password when the authentication information is used for grid-based authentication. In another embodiment, however, authentication server 304 may automatically select either or both of the sub-grid positions and character positions and provide those selections to user 308.

FIG. 8 is a flow diagram depicting a process 800 by authentication server 304 for authenticating user 308 based on a dynamically-generated, grid-based OTP, according to a non-limiting embodiment of the present disclosure. The process 800 may be considered side-by-side with FIGS. 6A-6B, 7A-7B, and 9A-B, which illustrate elements that may displayed to user 308 on one or more computing devices 902a-902b associated with user 308 during the authentication process.

The method begins at step 810 when authentication server 304 stores authentication information associated with user 308. According to certain embodiments, the authentication information includes at least one sub-grid position 610A-J selected from a plurality of sub-grid positions associated with a grid pattern 600. The authentication information also includes at least one character position selected from a plurality of character positions associated with a sub-grid pattern 700. According to certain embodiments, the selected sub-grid position(s) 610A-J and the selected character position(s) may have been selected by user 308 during a provisioning process such as that described above with respect to FIG. 5. In a particular embodiment, authentication server 304 may store the authentication information in memory 406, as described above with respect to FIG. 4.

At step 820, authentication server 304 generates an authentication grid 900 based on the stored authentication information. The generated authentication grid 900 may be converted into an image and transmitted to a computing device associated with the user, at step 830.

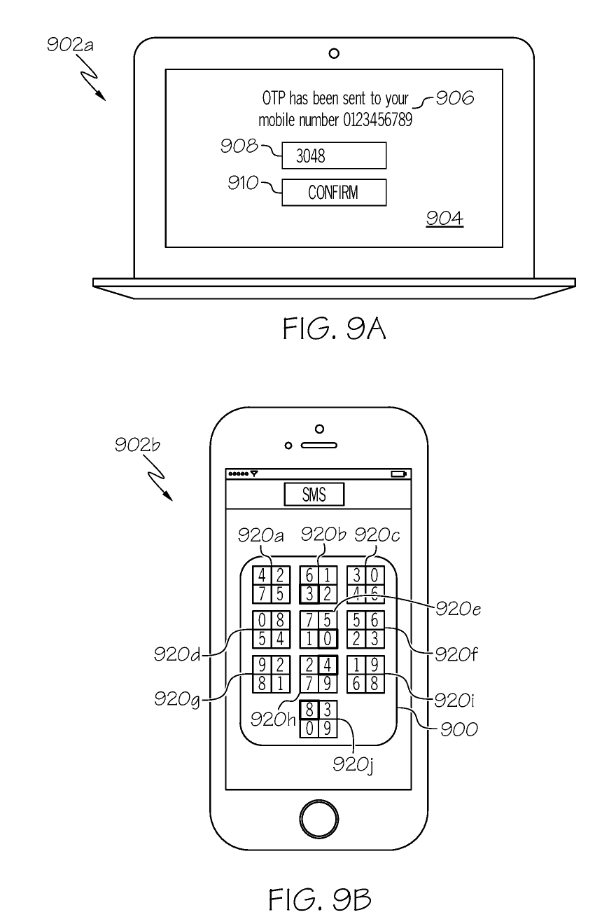

According to certain embodiments, authentication grid 900 may be generated and transmitted in response to receiving, by authentication server 304, an authentication request from a computing device associated with user 308. For example, assume in a particular embodiment, that user 308 is using a first computing device 902a, as depicted in FIG. 9A, to access an account or perform an online transaction. Prior to allowing the user to access the account or prior to finalizing the online transaction, GUI screen 904 may be displayed to user 308. In another embodiment, the authentication request may be received from a computing device being used to conduct a transaction associated with a user 308. For example, if the user 308 attempts to make a point-of-sale purchase at a brick-and-mortar store, the authentication request may be received from a computing device associated with the merchant.

GUI screen 904 includes elements for requesting entry of an OTP by user 308. For example, as depicted, GUI screen 904 includes a request message 906, a user input box 908, and a confirm button 910. In this particular example, request message 906 indicates that an OTP has been sent to second computing device 902b associated with user 308, and the OTP referred to in request message 906 is the authentication grid 900, which authentication server 304 transmitted to second computing device 902b in step 830.

According to certain embodiments, authentication grid 900 includes multiple sub-grids 920a-g disposed at respective sub-grid positions. Each sub-grid 920a-g includes multiple randomly selected characters that are each disposed at a respective character position within the sub-grid 920a-g. According to certain embodiments, authentication server 304 may use an algorithm to ensure normal distribution of all characters positioned in all possible character positions in the authentication grid 900.

In the particular example embodiment depicted in FIG. 9B, each sub-grid 920a-g includes four randomly-selected numerals. Specifically, sub-grid 920a includes the following randomly selected numerals: 7, 5, 2, and 4. However, it is generally recognized that sub-grids 920a-g of authentication grid 900 may be populated using numerals, alphabet characters, special characters, or any combination of these or other characters and may include any suitable number of characters selected for a desired level of security.

User 308 may determine a user-generated OTP based on the authentication grid 900 that is received as a result of step 830 and authentication information known to user 308 from the previous provisioning process. For example, assume that user 308 selected sub-grid positions 610B, 610E, 610H, and 610J in that order, as described above with respect to FIG. 6B. Sub-grid positions 610B, 610E, 610H, and 610J correspond generally to the positioning of sub-grids 920b, 920e, 920h, and 920J. Thus, from this “what is known” information, user 308 knows that the numerals included in the user-generated OTP must come from sub-grids 920b, 920e, 920h, and 920j in the same corresponding order.

Likewise, assume that user 308 selected the following selections from sub-grid pattern 700 as described above with regard to FIG. 7A: character position 710A-1 for sub-grid 710A, character position 710B-2 for sub-grid 710B, character position 710C-3 for sub-grid 710C, and character position 710D-4 for sub-grid 710D. From this “what is known” information, user 308 should select the numeral in the character position of sub-grid 920b that corresponds to character position 710A-1 of sub-grid 710A. In the depicted example, the corresponding numeral is ‘3’, as shown in the bolder outlined box in FIG. 9B. Accordingly, ‘3’ becomes the first character of the user-generated OTP entered into user input box 908.

Similarly, user 308 also selects the numeral in the character position of sub-grid 920e that corresponds to character position 710B-2 of sub-grid 710B. In the depicted example, the corresponding numeral is a ‘0’, as shown in the bolder outlined box in FIG. 9B. Accordingly, ‘0’ becomes the second character of the user-generated OTP entered into user input box 908.

Additionally, user 308 selects the numeral in the character position of sub-grid 920h that corresponds to character position 710C-3 of sub-grid 710C. In the depicted example, the corresponding numeral is a ‘4’, as shown in the bolder outlined box in FIG. 9B. Accordingly, ‘4’ becomes the third character of the user-generated OTP entered into user input box 908.

Finally, user 308 selects the numeral in the character position of sub-grid 920g that corresponds to character position 710D-4 of sub-grid 710D. In the depicted example, the corresponding numeral is an ‘8’, as shown in the bolder outlined box in FIG. 9B. Accordingly, ‘8’ becomes the fourth character of the user-generated OTP entered into user input box 908.

After arranging each of the numerals comprising the user-generated OTP comprising ‘3048’ in input box 908, user 308 may select the confirm button 910 to be authenticated. Though the numerals associated with ‘3’, ‘0’, ‘4’, and ‘8’ are shown emphasized in FIG. 9, this emphasis is provided for the understanding of the reader. Such emphasis would not be included in authentication grid 900 as displayed to user 308 during an actual transaction so as to prevent someone who might be observing the transaction from memorizing the positions.

Returning to the server perspective depicted in FIG. 8, the method continues at step 840 when authentication server 304 determines an OTP based on the authentication grid generated in step 820 and the authentication information that includes the at least one sub-grid position and the at least one character position selected by the user 308. The process for determining the OTP based on the grid and authentication information is similar to the analysis performed by the user 308 when determining what numerals to select from the authentication grid 900 for the user-generated OTP.

At step 860, authentication server 304 compares the first user input received at step 850 with the OTP generated at step 840. Authentication server 304 then authenticates the user based on the comparison. For example, if the first user input matches the OTP generated by the authentication server 304, the user is authenticated. Conversely, if the first user input does not match the OTP generated by authentication server 304, the user will not be authenticated. In a particular embodiment, a new authentication grid 900 may be generated and transmitted to the user's computing device in response to failed authentication.

Additionally, according to certain embodiments, authentication grid 900 may only be valid for a predetermined period of time, which may be monitored by authentication server 304. Thus, user 308 may be required to determine the user-generated OTP and enter user input into GUI screen 904 before the OTP expires. If the user-generated OTP is received after the expiration of the OTP, the user will not be authenticated.

Various modifications may be made to above described process for grid-based authentication within the scope of the disclosure. For example, although FIGS. 9A and 9B depict user 308 as using one computing device 902a to conduct the transaction and enter the user input comprising the user-generated OTP and another computing device 902b for receiving the authentication grid 900, the process may be carried out using a single computing device. Furthermore, though a laptop is depicted as being used to conduct the transaction and a mobile device is depicted as being used for receiving authentication grid 900, the depicted computing devices are provided merely as examples. Thus, any type or combination of types of computing devices may be used to carry out the above-described grid-based authentication techniques.

As still another example, the information transmitted to one computing device 902a may be duplicated to other computing devices 902b to avoid dependency on one computing device. For example, particular embodiments may send the authentication grid 900 to both the user's laptop and the user's mobile device. Accordingly, if the user 308 loses his mobile device, the user may still be authenticated using the laptop or another computing device associated with the user.

As still another example, although authentication grid 900 is depicted as being transmitted to the user 308 as a SMS message, it is recognized that authentication grid 900 may be additionally or alternatively transmitted to user in an email or any other suitable message that may be received on any computing device associated with user 308.

The figures illustrate the architecture, functionality, and operation of possible implementations of systems, methods, and computer program products according to various aspects of the present disclosure. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

While the present disclosure has been described in connection with preferred embodiments, it will be understood by those of ordinary skill in the art that other variations and modifications of the preferred embodiments described above may be made without departing from the scope of the invention. Other embodiments will be apparent to those of ordinary skill in the art from a consideration of the specification or practice of the invention disclosed herein. It will also be understood by those of ordinary skill in the art that the scope of the disclosure is not limited to use in a server diagnostic context, but rather that embodiments of the invention may be used in any transaction having a need to monitor information of any type. The specification and the described examples are considered as exemplary only, with the true scope and spirit of the invention indicated by the following claims.

What is claimed is:

1. A method by an authentication server, the method comprising:
storing authentication information associated with a user, the authentication information comprising:
at least one sub-grid position selected from a plurality of sub-grid positions associated with a grid pattern; and
at least one character position selected from a plurality of character positions associated with a sub-grid pattern;
generating an authentication grid comprising a plurality of sub-grids, each of the plurality of sub-grids being disposed at one of the plurality of sub-grid positions associated with the grid pattern, each of the plurality of sub-grids comprising a plurality of randomly selected characters, each of the randomly selected characters being disposed at a respective one of the plurality of character positions associated with the sub-grid pattern;
transmitting the authentication grid to at least one device associated with a user;
based on the authentication grid and the authentication information comprising that at least one sub-grid position and the at least one character position, determining a one-time password (OTP) for the user;
receiving, from the at least one device of the user, first user input comprising at least one character;
performing a comparison of the first user input to the OTP; and
based on the comparison, authenticating the user.

2. The method of claim 1, wherein the first user input comprises a user-generated OTP.

3. The method of claim 1, wherein the first user input comprises a plurality of characters, and each of the plurality of characters in the first user input comprises a number, letter, or special character.

4. The method of claim 3, wherein:
the plurality of characters in the first user input comprises at least four characters;
the authentication grid comprises at least four sub-grids disposed in at least four respective sub-grid positions; and
each of the four sub-grids comprises at least four randomly selected characters disposed in at least four respective character positions.

5. The method of claim 3, wherein each of the plurality of characters in the first user input are associated with a unique sub-grid within the authentication grid.

6. The method of claim 1, wherein transmitting the authentication grid to the at least one device associated with a user comprises sending a SMS message comprising the authentication grid to a mobile device associated with the user.

7. The method of claim 6, wherein receiving the first user input comprising the plurality of characters comprises receiving the first user input from a mobile application running on the mobile device associated with the user.

8. The method of claim 6, wherein receiving the first user input comprising the plurality of characters comprises receiving the first user input from a computer associated with the user.

9. The method of claim 1, further comprising:
prior to storing the authentication information associated with the user and generating the authentication grid:
transmitting, to the at least one device of the user, the grid pattern comprising the plurality of sub-grid positions;
transmitting, to the at least one device of the user, the sub-grid pattern comprising a plurality of character positions; and
receiving the authentication information comprising the at least one grid position and the at least one character position from user, wherein:
the at least one sub-grid position comprises a subset of the plurality of sub-grid positions as selected by the user;
the at least one character position comprises one of the plurality of character positions as selected by the user for each of the plurality of sub-grid positions in the subset.

10. The method of claim 9, wherein:
the first user input comprises n-number of characters, and
the subset of the plurality of sub-grid positions comprises n-number of sub-grid positions.

11. The method of claim 10, wherein n is selected based on a desired level of security such that n is greater for a higher level of security than for a lower level of security.

12. A non-transitory, computer-readable storage medium having instructions stored thereon, the instructions being executable by a computing system to cause the computing system to:
store authentication information associated with a user, the authentication information comprising:
at least one sub-grid position selected from a plurality of sub-grid positions associated with a grid pattern; and
at least one character position selected from a plurality of character positions associated with a sub-grid pattern;
generate an authentication grid comprising a plurality of sub-grids, each of the plurality of sub-grids being disposed at one of the plurality of sub-grid positions associated with the grid pattern, each of the plurality of sub-grids comprising a plurality of randomly selected characters, each of the randomly selected characters being disposed at a respective one of the plurality of character positions associated with the sub-grid pattern;
transmit the authentication grid to at least one device associated with a user;
based on the authentication grid and the authentication information comprising that at least one sub-grid position and the at least one character position, determine a one-time password (OTP) for the user;
receive from the at least one device of the user, first user input comprising at least one character;
perform a comparison of the first user input to the OTP; and
based on the comparison, authenticate the user.

13. The non-transitory, computer-readable storage medium of claim 12, wherein:
the first user input comprises a plurality of characters associated with a user-generated OTP, and
each of the plurality of characters in the first user input comprises a number, letter, or special character.

14. The non-transitory, computer-readable storage medium of claim 13, wherein:
the plurality of characters in the first user input comprises at least four characters;
the authentication grid comprises at least four sub-grids disposed in at least four respective sub-grid positions; and
each of the four sub-grids comprises at least four randomly selected characters disposed in at least four respective character positions.

15. The non-transitory, computer-readable storage medium of claim 13, wherein each of the plurality of characters in the first user input are associated with a unique sub-grid within the authentication grid.

16. The non-transitory, computer-readable storage medium of claim 12, wherein transmitting the authentication grid to the at least one device associated with a user comprises sending a SMS message comprising the authentication grid to a mobile device associated with the user.

17. The non-transitory, computer-readable storage medium of claim 16, wherein receiving the first user input comprising the plurality of characters comprises receiving the first user input from a mobile application running on the mobile device associated with the user.

18. The non-transitory, computer-readable storage medium of claim 12, wherein the instructions are further executable by the computing system to cause the computing system to:
prior to storing the authentication information associated with the user and generating the authentication grid:
transmit, to the at least one device of the user, the grid pattern comprising the plurality of sub-grid positions;
transmit, to the at least one device of the user, the sub-grid pattern comprising a plurality of character positions; and
receive the authentication information comprising the at least one grid position and the at least one character position from user, wherein:
the at least one sub-grid position comprises a subset of the plurality of sub-grid positions within the grid pattern selected by the user;
the at least one character position comprises one of the plurality of character positions as selected by the user for each of the plurality of sub-grid positions in the subset.

19. The non-transitory, computer-readable storage medium of claim 18, wherein:
the first user input comprises n-number of characters,
the subset of the plurality of sub-grid positions comprises n-number of sub-grid positions, and
n is selected based on a desired level of security such that n is greater for a higher level of security than for a lower level of security.

20. An authentication server comprising:
a memory storing authentication information for a plurality of users; and
processing circuitry with access to the memory, the processing circuitry configured to:
store authentication information associated with a user, the authentication information comprising:
at least one sub-grid position selected from a plurality of sub-grid positions associated with a grid pattern; and
at least one character position selected from a plurality of character positions associated with a sub-grid pattern;
generate an authentication grid comprising a plurality of sub-grids, each of the plurality of sub-grids being disposed at one of the plurality of sub-grid positions associated with the grid pattern, each of the plurality of sub-grids comprising a plurality of randomly selected characters, each of the randomly selected characters being disposed at a respective one of the plurality of character positions associated with the sub-grid pattern;
transmit the authentication grid to at least one device associated with a user;
based on the authentication grid and the authentication information comprising that at least one sub-grid position and the at least one character position, determine a one-time password (OTP) for the user;
receive from the at least one device of the user, first user input comprising at least one character;
perform a comparison of the first user input to the OTP; and
based on the comparison, authenticate the user.
